(19) United States
(12) Patent Application Publication
(10) Pub. No.: US 2007/0268255 A1
(43) Pub. Date: Nov. 22, 2007

(54) Computer pointing device with laser safety apparatus

(75) Inventor: Wen-Sheng Kuo, Sijhih City (TW)

Correspondence Address: BIRCH STEWART KOLASCH & BIRCH, PO BOX 747, FALLS CHURCH, VA, 22040-0747, US

(73) Assignee: Behavior Tech Computer Corp.

(21) Appl. No.: 11/730,859

(22) Filed: Apr. 4, 2007

(30) Foreign Application Priority Data
May 18, 2006 (TW) 95117617

(51) Int. Cl. G09G 5/08; G06F 3/033

(52) U.S. Cl. 345/166

(57) ABSTRACT

A laser pointing device having a laser safety apparatus is provided. The laser pointing device includes a laser sensor and a switch. The laser sensor is coupled to a laser diode and a controller. The switch has an end coupled to a power, and another end electrically coupled to the laser diode. When the laser pointing device is placed on a surface, the switch is in an ON state such that the power and the laser diode are electrically connected/When the laser pointing device is away from the surface, the switch is in an OFF state such that the power and the laser diode are electrically disconnected.

### RELATED APPLICATIONS

This application claims priority to Taiwan Application Serial Number 95117617, filed May 18, 2006, which is herein incorporated by reference.

### BACKGROUND

1. Field of Invention

The present invention relates to a computer pointing device.

2. Description of Related Art

The laser pointing devices, such like the laser computer mice, are becoming the main stream of the optical pointing devices. The laser diode components in the conventional laser pointing devices would generate laser beams when the conventional laser pointing devices are functioning. Hence, it becomes an important issue to control the laser beam generated by the laser diode components to conform to the safety standard.

Further, it is disclosed in the prior art that the power switch of the conventional optical computer mouse is installed on the housing of the conventional optical computer mouse. The power switch is set on and the power of the battery is provided to the conventional optical computer mouse only when the user is operating the conventional optical computer mouse. On the other hand, the power switch is set off and the power of the battery is no more provided when the computer is shut down.

Though it is designed in the prior art as described above to cut off the power provided by the battery when the conventional laser pointing device is not used. However, the laser diode of the conventional laser pointing device may still generate laser beam and emit the laser beam arbitrarily when the conventional laser pointing device with the power set on is not used regularly, such as when the conventional laser pointing device is lifted from the desk and is hanged in the air, which is dangerous and cannot be ignored.

Therefore, it is necessary to introduce a laser pointing device having a laser safety apparatus to improve the safety of the laser pointing device.

### SUMMARY

It is therefore an aspect of the present invention to provide a laser pointing device with a laser safety apparatus.

In accordance with the foregoing and other aspects of the present invention, a laser pointing device having a laser safety apparatus is provided. The laser pointing device includes a laser sensor and a switch. The laser sensor is coupled to a laser diode and a controller. The switch has an end coupled to a power, and another end electrically coupled to the laser diode. When the laser pointing device is placed on a surface, the switch is in an ON state such that the power and the laser diode are electrically connected/When the laser pointing device is away from the surface, the switch is in an OFF state such that the power and the laser diode are electrically disconnected.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating a bottom view of a laser pointing device according to a first embodiment of the present invention;

FIG. 2 is a structural diagram of the laser pointing device having the laser safety apparatus according to the first embodiment of the present invention;

FIG. 3 is a circuit diagram of the first embodiment of the present invention;

FIG. 4 is a structural diagram of the laser pointing device having the laser safety apparatus according to the second embodiment of the present invention; and

FIG. 5 is a circuit diagram of the second embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The laser pointing device having a laser safety apparatus is aimed for improving the safety of the laser pointing device. In a laser pointing device, such like a laser computer mouse, a laser diode is utilized to emit laser beam to a surface. When correctly using the laser pointing device, the emitted laser beam exists only between the laser pointing device and a small area of the surface. Therefore, the laser beam does not exert any influence to the user. However, when the laser pointing device is used incorrectly or irregularly, and the laser beam does not emit to the surface but to the human body, in one extreme example, to the human eye balls, which is very likely to hurt the user. The laser safety apparatus of the laser pointing device according to the present invention avoids such dangerous situation. The present laser safety apparatus disables the laser diode, for example, by cutting off the power provided to the laser diode, such that the laser diode cannot emit laser beams any more. In another embodiment, the laser safety apparatus of the present invention may reduce the emitting power of the laser diode such that the laser beam generated by the laser diode is weak and not harmful to human beings, especially to the eye balls.

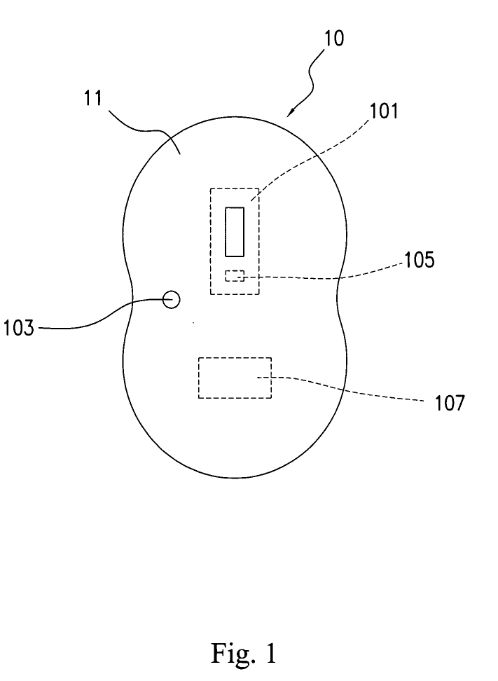

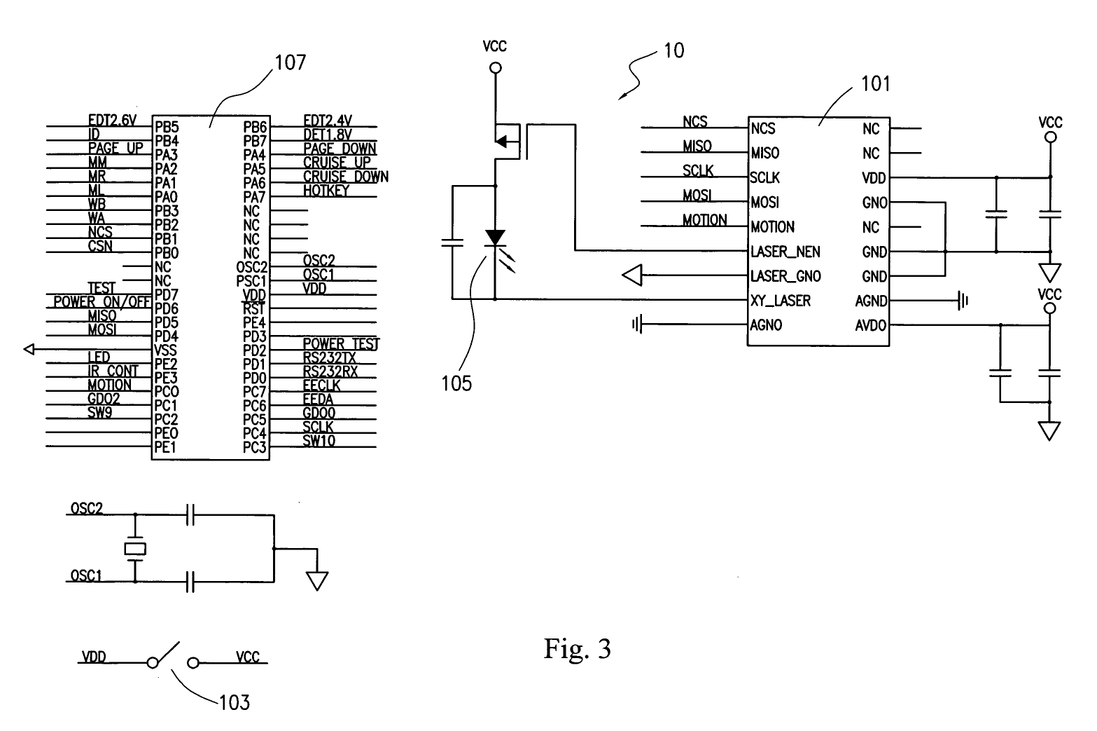

FIG. 1 is a diagram illustrating a bottom view of a laser pointing device according to a first embodiment of the present invention. The switch 103 can be implemented by a limit switch. The limit switch 103 in FIG. 3 is installed in the base 11 of the laser pointing device 10, and the limit switch 103 contacts the surface. When the limit switch 103 contacts the surface, that is, when the laser pointing device 10 is placed one the surface, the user is very likely to operate and control the laser pointing device 10 anytime. The limit switch 103 is in an ON state then. On the other hand, the limit switch 103 in FIG. 3 is in an OFF state (open circuited) when the limit switch 103 is away from the surface.

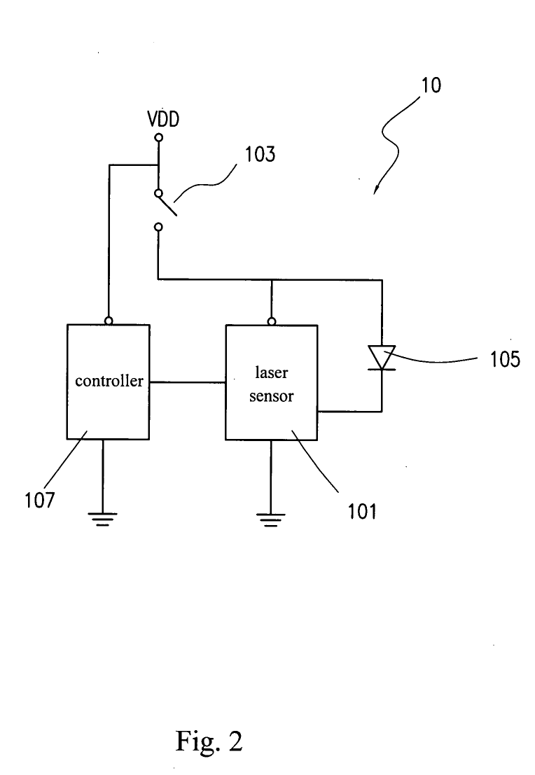

FIG. 2 illustrates a structural diagram of the laser pointing device having the laser safety apparatus according to the first embodiment of the present invention. The present laser pointing device 10 equipped with the laser safety apparatus includes at least: a laser sensor 101, a switch 103, a laser diode 105, and a controller 107. The laser sensor 101 is coupled to the laser diode 105 and the controller 107. The controller 107 is utilized to receive a pointing signal generated by the laser sensor 101.

One end of the switch 103 is coupled to the power, for example, a battery module. The other end of the switch 103 is coupled to the laser diode 105. When the laser pointing device 10 is placed on a surface, such like a desk or a computer mouse pad, the switch 103 is in an ON state and the power and the laser diode 105 are electrically connected. That is, the laser diode 105 is provided with the power. On the other hand, when the laser pointing device 10 is removed from the surface, for example, when the user holds the laser mouse 10 and lifts it to the head of the user, the switch 103 of the laser pointing device 10, which is away from the surface, is in an OFF state, disconnecting the power and the laser diode 105. That is, the power is not provided to the laser diode 105 accordingly.

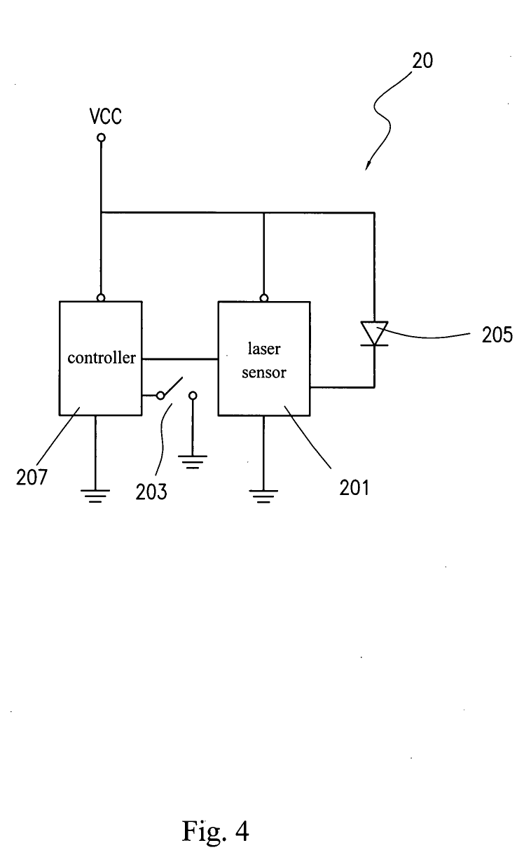

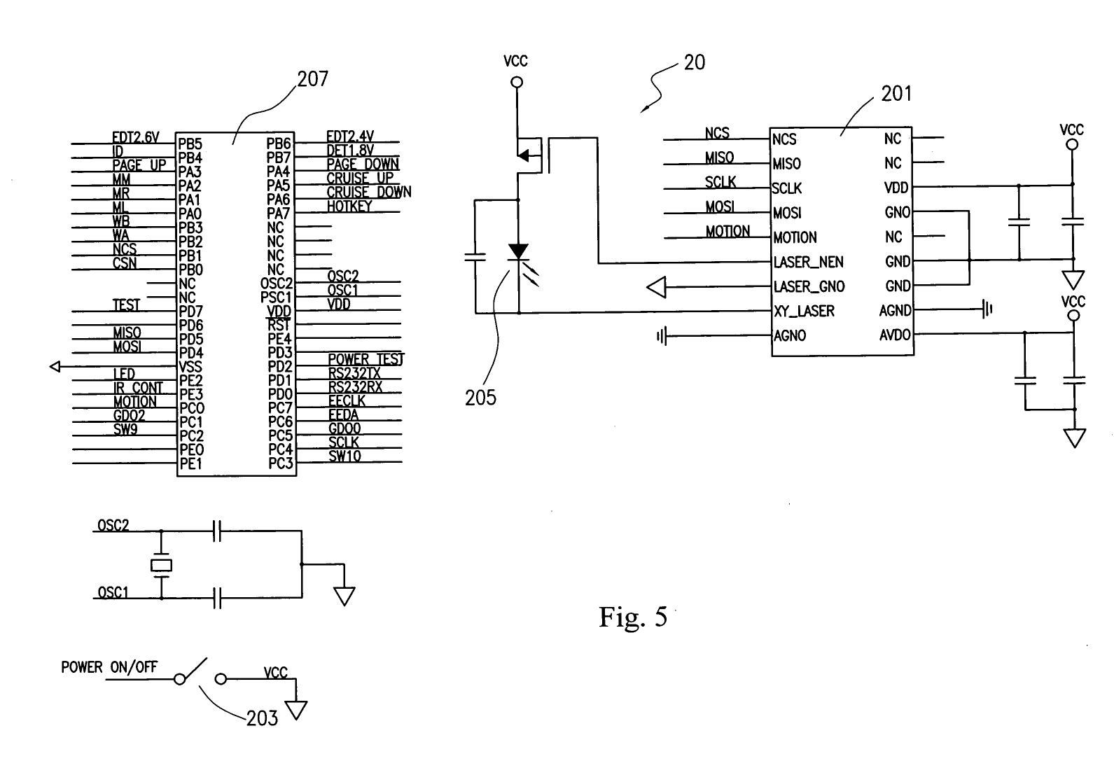

FIG. 4 illustrates a structural diagram of the laser pointing device having the laser safety apparatus according to the second embodiment of the present invention, and FIG. 5 illustrates a circuit diagram of the second embodiment of the present invention. The laser pointing device 20 having a laser safety 10 apparatus includes at least: a laser sensor 201, a switch 203, a laser diode 205, and a controller 207. The laser sensor 201 is coupled to the laser diode 205 and the controller 207. The controller 207 is utilized to receive a pointing signal generated by the laser sensor 201.

The switch 203 is coupled to the controller 207, providing voltage level signals to the controller 207. The switch 203 may be implemented by a limit switch, which is designed to cut off power automatically at or near the limit of travel of the laser pointing device 20. Similarly, the limit switch 203 can be installed just like the switch 103 is in FIG. 1. When the laser pointing device 20 is placed on a surface, the limit switch 203 is in an ON state, while the limit switch 203 is switched to an OFF state when the laser pointing device 20 is removed from the surface.

The controller 207 is utilized to detect a current state of the switch 203. When it is detected by the controller 207 that the switch 203 is in an OFF state, the controller 207 transmits a command packet to the laser sensor 201 for restraining the laser diode 205. The laser sensor 201 receives the command packet and disables the laser diode 205, or reduces the transmission power of the laser diode 205 to a safe range to human beings, such that the weak laser beam is not harmful to human bodies, especially the eye balls, in accordance.

Alternately, when it is detected by the controller 207 that the switch 203 is in an ON state, the controller 207 performs conventional procedures correspondingly since there is no corresponding regulation introduced in the present invention.

The limit switch adopted by the aforementioned switches 103 and 203 is only an exemplary but not restrictive embodiment in the present invention. Any switch scheme that is able to detect whether the laser pointing devices 10 and 20 are on a surface or not is within the spirit and scope of the present invention.

The implementations of the laser pointing devices 10 and 20 of the present invention may include a laser mouse, a laser track ball, and other laser pointing device that comprises a laser diode.

In summary, the main advantage of present invention is that the laser pointing device of the present invention utilizes a laser safety apparatus to substantially reduce the danger of the laser bean emitted by the laser diode and improve the safety of the laser pointing device.

Although the present invention has been described in considerable detail with reference to certain preferred embodiments thereof, other embodiments are possible. Their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A laser pointing device having a laser safety apparatus, the laser pointing device comprising:
a laser diode;
a controller;
a laser sensor, coupled to the laser diode and the controller; and
a switch, having an end coupled to a power, and another end electrically coupled to the laser diode, wherein when the laser pointing device is placed on a surface, the switch is in an ON state, such that the power and the laser diode are electrically connected; and when the laser pointing device is away from the surface, the switch is in an OFF state, such that the power and the laser diode are electrically disconnected.

2. The laser pointing device of claim 1, wherein the switch is a limit switch.

3. The laser pointing device of claim 2, wherein the limit switch is installed in a base of the laser pointing device and in contact with the surface.

4. The laser pointing device of claim 1, wherein the controller is utilized to receive a pointing signal generated by the laser sensor.

5. The laser pointing device of claim 1 being one of a laser mouse or a laser trackball.

6. The laser pointing device of claim 1, wherein a transmission power of the laser diode is within a safe range to human beings, not harmful to human eyes.

7. A laser pointing device having a laser safety apparatus, the laser pointing device comprising:
a laser diode;
a controller;
a laser sensor, coupled to the laser diode and the controller; and
a switch, having an end coupled to the controller, wherein when the laser pointing device is placed on a surface, the switch is in an ON state, and when the laser pointing device is away from the surface, the switch is in an OFF state.

8. The laser pointing device of claim 7, wherein the switch is a limit switch.

9. The laser pointing device of claim 8, wherein the limit switch is installed in a base of the laser pointing device, and the limit switch contacts the surface.

10. The laser pointing device of claim 7, wherein the controller is utilized to receive a pointing signal generated by the laser sensor, and the controller is utilized to detect a current state of the switch; wherein when a result detected by the controller is the switch is in an OFF state, the controller commands the laser sensor to disable the laser diode, or the controller commands the laser sensor to reduce a transmission power of the laser diode to a safe range to human beings.

11. The laser pointing device of claim 7 being one of a laser mouse and a laser trackball.

12. The laser pointing device of claim 7, wherein a transmission power of the laser diode is within a safe range to human beings, not harmful to human eyes.
